(19) United States
(12) Patent Application Publication
(10) Pub. No.: US 2005/0058346 A1
(43) Pub. Date: Mar. 17, 2005

(54) Apparatus and method for determining selection data from pre-printed forms

(76) Inventor: James Au-Yeung, Surrey (GB)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(21) Appl. No.: 10/494,070

(22) PCT Filed: Oct. 14, 2002
(86) PCT No.: PCT/GB02/04639

(30) Foreign Application Priority Data
Oct. 31, 2001 (GB) 0126190.8

(51) Int. Cl. G06K 9/18; G06F 17/60

(52) U.S. Cl. 382/184; 705/12

(57) ABSTRACT

The present invention provides for a method of determining selection data from a pre-printed form offering a plurality of choices or a respondent, including processing the marked form by means of optical character recognition and including the step of conducting optical character recognition of the marked form to identify choices not distorted and therefore allow for the identification of the distorted, and thus, selected data

The present invention relates to an apparatus and method for determining selection data from pre-printed forms, and in particular to a technique for extracting data automatically from forms where a range of answers are available for selection.

In the present application, the term pre-printed refers to the form offering a selection of answers/choices for the user prior to the choice being made.

A variety of forms where the users., or respondents, are required to select from a range of given answers are used daily for many purposes including consumer questionnaires, multiple choice question answer sheets, lottery entry forms and election ballot papers. Such forms are processed using Optical Marker Recognition (OMR) technology which is expensive and relies on careful marking, for example with a specific grade of pencil such as HB. Special colored inks (usually, pink and yellow) are also required to print the forms so that they are “invisible” to the OMR. School teachers, however, still need to mark the answer sheets manually. Lottery forms are also processed with dedicated machines using similar OMR technique. OMR software is also used by large organization companies to process frequently used forms such as questionnaires. Such software is often expensive and requires special training to operate. Most often a circle of a particular size has be filled in a particular manner to facilitate recognition and then the choice made by the respondent. Also the majority of these forms are still being processed manually which is a slow, expensive and inaccurate procedure. Most election ballot papers are currently counted manually and many recounts are need as a result. Some ballot papers in certain countries are machine-read but errors and disputes still arise. OMR processing operates so as to subtract the graphical image of the filled from that of the unfilled form to extract the entries i.e. marks made by the respondent completing the form. Such processing then serves to calculate the precise location of the marks on the page.

As mentioned, this known processing technique is prohibitively expensive and complex and not generally reliable.

The invention seeks to provide for a method and apparatus for determining selection data and which exhibits advantages over such known methods and apparatus.

According to one aspect of the present invention there is provided a method of determining selection data from a pre-printed form marked by a respondent and including processing the marked form by means of optical character recognition processing.

The present invention is particularly advantageous in that, being arranged to employ optical character recognition processing, automated handling of forms can be achieved in a much more cost-effective, quicker and efficient manner than is currently known. Such advantages are achieved through reversing the processing concept currently employed which seeks to specifically identify the choice made by the respondent. Rather, in accordance with the present invention, the method and apparatus operates so as to identify, through Optical Character Recognition (OCR) technology, the choices that have not been selected and thereby, through a comparative process of elimination, identify the actual choice that was made.

Preferably therefore, the invention advantageously provides for a method of determining selection data for a pre-printed form offering a plurality of choices to be marked by a respondent in a distorting manner, wherein optical character recognition serves to identify the possible choices not distorted and thereby allow for ready identification of the distorted, and thus selected, choice.

The method can involve the respondent making its choice through any appropriate mechanism for distorting the data entry relating to that choice, for example either by marking-through the choice, obliterating or over marking the choice or merely in circling the choice.

Advantageously, the method of the present invention can be carried out by use of readily available hardware configuration including, for example, a standard PC, scanner and optical character recognition software.

According to another aspect of the present invention, there is provided an apparatus for determining selection data from a pre-printed form marked by a respondent, and including optical character recognition means for processing the marked form.

The apparatus of the present invention can advantageously be arranged to execute any one or more of the processing steps defined above.

According to an embodiment of the present method a computer, an office optical scanner equipped with a document feeder and software comprising an Optical Character Recognition (OCR) capability are needed to automate the data extraction process. The selection of one or more answers by a respondent is achieved by marking the answers so that the choice is “distorted” optically and this cannot be recognized by the OCR software as the original character. The software compares the character sequence of an unmarked form with that of a completed form and any discrepancies between the two are then treated as the selected answers. The character sequence of the unmarked form can either be scanned in using the OCR based software as the template for comparison, or can be generated by the software with an extra form generation component. With the former, the user needs to specify which particular character sequence corresponds to the expected answers. The latter is the preferred way where all answers can be determined by the software.

The invention is described further hereinafter, by way of example only, in which:

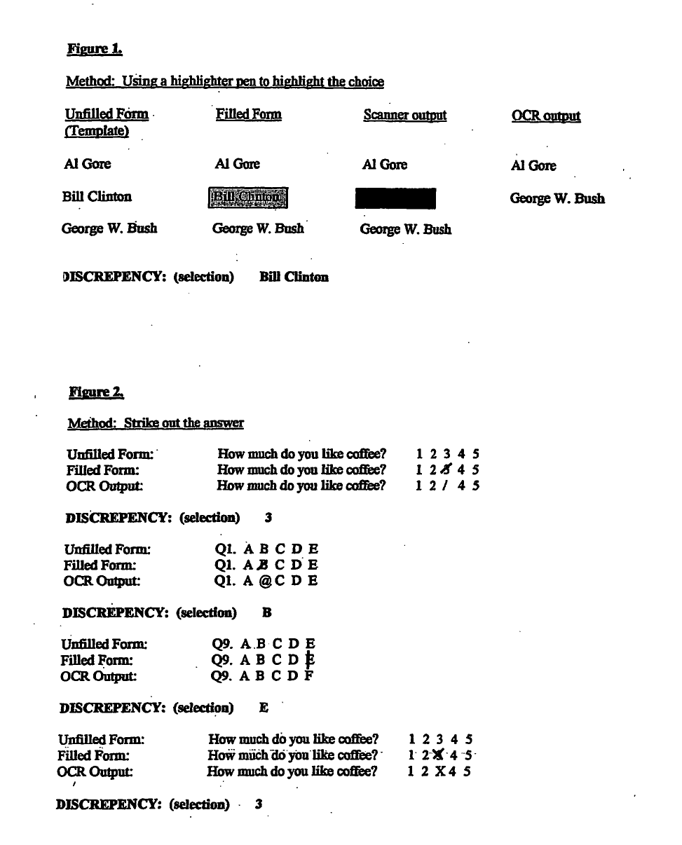

FIG. 1 illustrates a first embodiment of the invention utilizing a highlighter to make a selection;

FIG. 2 illustrates a second embodiment in which a choice is marked by striking it out;

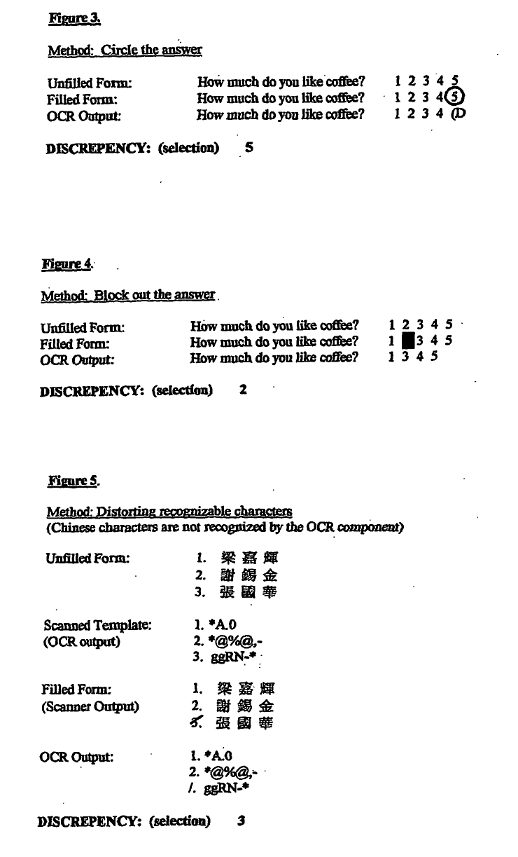

FIG. 3 illustrates a third embodiment in which a choice is circled;

FIG. 4 illustrates a forth embodiment where a choice is blocked out;

FIG. 5 is an illustration of the invention working with non-English texts; and

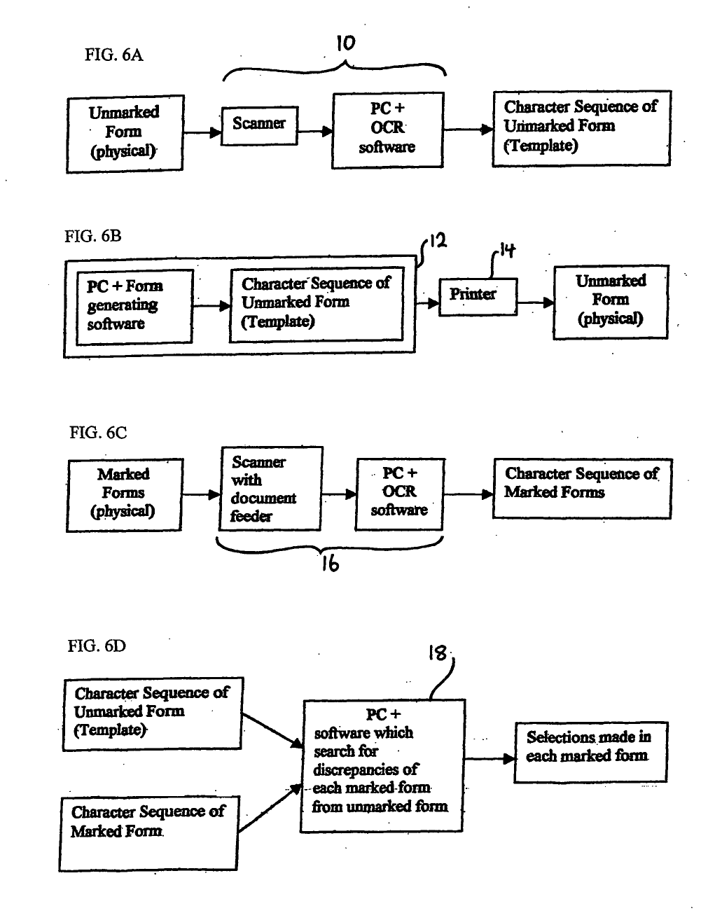

FIGS. 6A to 6D comprise schematic block diagrams of one embodiment of the invention.

There are different ways that a form can be marked by a respondent in order to record their choice. In FIG. 1, a ballot paper with a list of candidates is presented. At the polling station, a voter will be asked to highlight a candidate using a highlighter pen. An office optical scanner can then be used in accordance with the invention to scan the completed ballot papers. By setting the sensitivity of the scanner, the highlighted area will appear as a black block on the scanner output. This black block cannot be recognized by the OCR component and the output is blank for the highlighted character sequence. A simple comparison of the character strings of the template i.e. a version of the unmarked form by way of the OCR software serves to reveal the discrepancy which then identifies the selected candidate. A scanner equipped with a document feeder can process a high volume of ballot papers where the software can tally the total vote for different candidates. Advantageously, such a highlighting-based system comprises a clear marking system where the choice would be less likely to be disputed than systems such as those employing physical punching where punching is not completed. Marking by means of highlighting in this manner would also assist manual recounts should the need arise.

Also, the use of a highlighting marker is particularly appropriate for use in voting systems wherein changes to the ballot slip are not permitted. A new ballot slip is then required if changes need to be made. For other applications where changes could be allowed, pencil marking is then considered to be more appropriate. FIGS. 2-4 show various ways in which a selected answer can be distorted optically for identification by the OCR software. FIG. 2 illustrates an example in which one of the answers is marked through with a line or cross. A further method illustrated in FIG. 3 involves the circling of a choice which is a popular method employed in current consumer questionnaires. Another method illustrated in FIG. 4 is to block out the answer completely.

The OCR component fails to recognize the distorted characters and so returns a result indicating a completely different character or symbol or fails to produce a character sequence at all. A simple comparison between the template comprising the unmarked form and the OCR output would reveal the selections made by the respondent who filled out the questionnaire/form/answer sheet.

Of course an OCR component for particular alphabets can also be used for efficiency process forms for other character sets. Also, for non-latin texts and symbols, for example, Chinese characters, which cannot be recognized by the OCR component, these can effectively be ignored completely by the software. In FIG. 5, nonsense character sequences of the Chinese characters are output but through comparison with the scanned template, the selection can be readily determined. As long as recognizable numeric alphabets are used, for example, at the beginning, which can be recognized by, for example, the OCR English script component, all the methods described in FIGS. 1-4 can be used to distort the numeric part. The software can easily accommodate such comparison to extract the correct information.

Turning now to FIGS. 6A-6D there is an embodiment of the present invention illustrated by means of a schematic block diagram.

This illustrated embodiment of the present invention represents a particularly simplified form of the present invention through its use of relatively standard, and readily available, hardware and software components. In this illustrated example, there is first illustrated both FIGS. 6A and 6B, means for generating an unmarked selection form which, in subsequent steps of the process, forms a comparison template, which template is subsequently compared as illustrated in FIG. 6D with an image retrieved from a marked form so as to identify the selected option.

In accordance with FIG. 6A, there is provided a scanner, PC and OCR software combination 10 which can be arranged to receive an unmarked form and to produce character sequences of the unmarked form that serve as the aforementioned template.

With reference to FIG. 6B, there is illustrated an alternative of likewise generating an unmarked form by means of a combination of form generating and character sequence processing software 12 which can be arranged to drive a printer 14. In the version of FIG. 6A, the processing commences with a physical version of an unmarked form which is then reduced to an electronic template format, whereas in FIG. 6B, a “soft” version of the form is first generated by the processing combination 12 and which can then serve as the subsequent template, while the printer output device 14 allows for the generation of the physical unmarked form for subsequent marking by a respondent.

Turning now to FIG. 6C, a form as marked by a respondent is delivered to a scanner, PC and OCR software combination 16 so as to produce so that, once scanned and processed, a character sequence representative of the characters recognized on the marked form is produced. The said produced character sequence is then compared with a character sequence represented of the unmarked form, i.e. the output from stages represented by FIGS. 6A and 6C are combined in accordance with FIG. 6D by means of an appropriately configured PC 18 so that discrepancies between the character sequences can readily be identified. In the final stage represented by FIG. 6D, there is no further OCR processing required and character sequence comparison is all that is required so as to identify the selections made by the respondent on the form.

As should therefore be appreciated, in the illustrated embodiment, the scanner output comprises a sampled version of the graphical image consisting of rows and columns of pixels. It has been found that a pixel resolution of 150 dpi (dots per inch) is sufficient for the OCR related processing and an OCR program is used to translate the pixel information into alphanumeric characters. Basic OCR software that currently is associated with most commercially available scanners is suitable for use within the invention and can employ either of the two basic methods of OCR, namely matrix matching and feature extraction. In both methods, individually isolated windows of pixels are processed in turn. For each window that fails to be recognized as a known character, the window is be resized either being subdivided into similar windows or to be recombined with neighboring windows to become part of a large window. The newly formed window(s) will undergo the same process until a certain confidence is reached that a particular character is identified or recognized.

The OCR process outputs a file containing a sequence of characters. The file can be read in by a computer program one line at a time and blank lines which contain no characters, or only white spaces, are not processed. The comparison process compares the two files line by line and for each line, a character by character comparison is conducted. Two lines are considered identical if all characters in the lines match or if the differences are only in the number of white spaces between characters.

When a discrepancy occurs, the current character in the template file is the “distorted” character. For example, in FIG. 2, the example “Q1. A B C D E”, the first distorted character is “B” which is the struck out answer. The computer program then checks the rest of the characters in the line to check if more than one character is distorted.

When a whole line is missing, for example in FIG. 1, the whole line is distorted. To detect if a line is missing, for example line 2 “Bill Clinton”, the current line in the template file is found to be different from the current line in the scanned-in file i.e. line 2 “George W. Bush”. The next line from the template file, i.e. line 3 “George W. Bush” is used to compare with the current line namely line 2 “George W. Bush”. If a match is found, then the current line of the template—line 2 “Bill Clinton”—can be confirmed to be missing. The rest of the lines in the template files are compared in the same way.

As will therefore be appreciated, the invention advantageously provides for a method of extracting data selections made on a pre-printed form utilizing OCR technology. The method is based on distorting the character based answer selections optically to hinder the recognition by the OCR component. As noted, the answer selections are computed by comparing the undistorted version (original form) with the distorted version (the filled form) and the distorting method can involve highlighting answers using a highlighter with reference to FIG. 1 of the accompanying figures. On this basis it should be appreciated that the invention does not require actual character recognition by the OCR processing means. It is generally merely required that signals representative of the characters scanned be generated for subsequent comparison purposes such as illustrated in FIG. 6D. Thus within the present application reference to optical character recognition processing does not require final recognition of a character. Of course, the invention can employ OCR processing characteristics that are adapted to any particular language and script such as Chinese and Japanese etc.

1. A method of determining selection data from a pre-printed form offering a plurality of choices for a respondent, including processing the marked form by means of optical character recognition processing.

2. A method as claimed in claim 1, and including conducting optical character recognition processing against the marked form to identify choices not distorted and therefore allow for the identification of the distorted, and thus, selected data.

3. A method as claimed in claim 1, and including the step of comparing the marked form with an unmarked version in order to determine the selected data.

4. A method as claimed in claim 3, and including the step of comparing a blank template of the form with the marked form.

5. A method as claimed in claim 2, wherein the respondent distorts the selected data on the form by marking through the said data.

6. A method as claimed in claim 2 wherein the respondent distorts the selected data on the form by obliterating the said data.

7. A method as claimed in claim 2, wherein the respondent distorts the selected data on the form by over-marking the said data.

8. A method as claimed in claim 2 wherein the respondent distorts the selected data on the form by in circling the said data.

9. A method as claimed in claim 1 and conducted by means of a PC, scanner and optical character recognition software.

10. An apparatus for determining selection data from a pre-printed form marked by a respondent, and including optical character recognition means for processing the marked form.

11. (Cancelled)

12. An apparatus as claimed in claim 10 and including a PC, scanning means and optical character recognition software.

13-14. (Cancelled)
